(19) United States
(12) Patent Application Publication
(10) Pub. No.: US 2018/0145329 A1
(43) Pub. Date: May 24, 2018

(54) NEGATIVE ELECTRODE FOR NONAQUEOUS ELECTROLYTE ENERGY STORAGE DEVICE

(71) Applicant: GS Yuasa International Ltd., Kyoto-shi, Kyoto (JP)

(72) Inventors: Hiroaki ENDO, Kyoto (JP); Toshiyuki AOKI, Kyoto (JP); Hiro FURIYA, Kyoto (JP)

(21) Appl. No.: 15/569,831

(22) PCT Filed: Apr. 25, 2016
(86) PCT No.: PCT/JP2016/002177

§ 371 Date: Oct. 27, 2017

(30) Foreign Application Priority Data
Apr. 28, 2015 (JP) 2015-092009

(51) Int. Cl. H01M 4/587; H01G 11/38; H01G 11/06; H01M 4/505; H01M 4/525; H01M 10/0525; H01M 4/62; H01M 2/16; H01M 10/0569; H01M 10/0587; H01M 10/0568

(52) U.S. Cl. CPC H01M 4/587; H01G 11/38; H01G 11/06; H01M 4/505; H01M 4/525; H01M 2004/027; H01M 4/622; H01M 2/16; H01M 10/0569; H01M 10/0587; H01M 10/0568; H01M 10/0525

(57) ABSTRACT

Provided is a negative electrode for a nonaqueous-electrolyte energy storage device containing graphite, non-graphitizable carbon, and a binder. An average particle size of the non-graphitizable carbon is 8 μm or less. A ratio of the mass of the non-graphitizable carbon to a total mass of the graphite and the non-graphitizable carbon is 10% by mass or more and 50% by mass or less.

### TECHNICAL FIELD

The present invention relates to a negative electrode for a nonaqueous electrolyte energy storage device, and a nonaqueous electrolyte energy storage device and an energy storage apparatus, each using the same.

### BACKGROUND ART

In recent years, nonaqueous electrolyte energy storage devices typified by a lithium ion secondary battery has been used in wide applications of a power supply for electric vehicles, a power supply for electronic equipment, a power supply for electric power storage and the like.

Development of a high-performance nonaqueous electrolyte energy storage device of low cost is required as the use of the nonaqueous electrolyte energy storage device prevails.

As one of efforts on such development, investigations have been made concerning a configuration of a negative electrode.

Patent Document 1 discloses a technology of “A composite for a negative electrode which contains a negative active material to be used for a lithium ion secondary battery wherein the composite for a negative electrode contains a negative active material, a binder, a layered compound, and a dispersion medium, and the dispersion medium is water” (Claim 1).

Furthermore, “The composite for a negative electrode according to any one of claims 1 to 10, wherein the negative active material contains hard carbon” (Claim 11) and “The composite for a negative electrode according to any one of claims 1 to 11, wherein the negative active material contains graphite” (Claim 12) are disclosed.

Patent Document 2 discloses a technology of “A lithium secondary battery including a positive electrode, a negative electrode, and a nonaqueous electrolyte solution, wherein a lithium-containing nickel-cobalt composite oxide represented by a general formula LiNi₁₋ₓCoₓO₂ (satisfying the condition of 0.1≤x≤0.6) is used for the positive electrode, a carbon material containing natural graphite in an amount of 60 to 90% by weight and non-graphitizable carbon in an amount of 40 to 10% by weight is used for the negative electrode, and as the nonaqueous electrolyte solution, a nonaqueous electrolyte solution in which a self-diffusion coefficient of ⁷Li nucleus calculated by a pulsed-field-gradient proton NMR method is 1.5×10⁻⁶ cm²/s or more, is used” (Claim 1).

### PRIOR ART DOCUMENTS

### Patent Documents

Patent Document 1: JP-A-2013-134896

Patent Document 2: JP-A-2002-252028

### DISCLOSURE OF THE INVENTION

### Problems to be Solved by the Invention

When a negative composite paste containing an aqueous solvent is used on a negative current collecting foil as a binder to be used for a negative electrode, there is a large economical advantage on a production process that a step of recovering a solvent can be omitted or handling of a paste is easy compared with the case of using a nonaqueous solvent. Further, an environmental burden can be reduced. However, the present inventors have found that in the nonaqueous electrolyte energy storage device using a negative electrode including a negative composite layer thus prepared, DC resistance at low temperatures is increased.

Patent Documents 1 and 2 describe that graphite and non-graphitizable carbon (hard carbon) are used as a negative active material.

However, a means for overcoming an increase of DC resistance at low temperatures is not referred to.

The present invention has been made in view of the above state of the art, and it is an object of the present invention to reduce DC resistance at low temperatures of a negative electrode for a nonaqueous electrolyte energy storage device including a negative composite layer prepared with use of an aqueous solvent.

### Means for Solving the Problems

One aspect of the present invention pertains to a negative electrode for a nonaqueous electrolyte energy storage device containing graphite, non-graphitizable carbon, and a binder. An average particle size of the non-graphitizable carbon is 8 μm or less. A ratio of the mass of the non-graphitizable carbon to a total mass of the graphite and the non-graphitizable carbon is 10% by mass or more and 50% by mass or less.

### Advantages of the Invention

According to one aspect of the present invention, the DC resistance a low temperatures of the negative electrode for a nonaqueous electrolyte energy storage device can be reduced.

### BRIEF DESCRIPTION OF THE DRAWINGS

FIG. 1 is a perspective appearance view showing an embodiment of a nonaqueous electrolyte energy storage device of the present invention.

FIG. 2 is a schematic view showing an energy storage apparatus having a plurality of the nonaqueous electrolyte energy storage devices assembled according to the present invention.

### MODE FOR CARRYING OUT THE INVENTION

The configuration and effects of the present invention will be described together with the technical concept. However, the operation mechanism includes presumptions, and whether it is right or wrong does not limit the present invention. The present invention can be performed in other various forms without departing from the spirit or main feature thereof. Accordingly the embodiments and experimental examples given below are merely examples in every way and they should not be construed as restrictive. Further, variations and modifications falling under the scope equivalent to the claims are all within the scope of the present invention.

In the embodiment of the present invention, a negative electrode for a nonaqueous electrolyte energy storage device contains graphite, non-graphitizable carbon, and a binder. An average particle size of the non-graphitizable carbon is 8 μm or less. A ratio of the mass of the non-graphitizable carbon to a total mass of the graphite and the non-graphitizable carbon is 10% by mass or more and 50% by mass or less.

DC resistance at low temperatures can be reduced by employing a negative electrode for a nonaqueous electrolyte energy storage device having such a constitution.

Herein, the graphite refers to carbon in which a distance between lattice planes of a (002) plane d(002) is 0.34 nm or less. Examples of the graphite include graphites such as natural graphite and synthetic graphite, graphitized products and the like.

A part of or all of the surface of the graphite particle may be covered with a carbon material other than the graphite. When the carbon material includes the non-graphitizable carbon, the non-graphitizable carbon with which a surface of the graphite particle is covered is considered as a part of the graphite particle and is not included in a mass of the non-graphitizable carbon.

As an average particle size of the graphite, the average particle size of 5 μm or more and 50 μm or less can be used. The average particle size is preferably 8 μm or more and 40 μm or less.

The non-graphitizable carbon refers to carbon in which a distance between lattice planes of a (002) plane d(002) is larger than 0.36 nm.

Herein, the average particle sizes of the graphite and the non-graphitizable carbon each refer to a particle size at which a cumulative degree is 50% (D50) in a particle size distribution on a volume basis.

Specifically a particle size distribution measurement apparatus of laser diffraction type (SALD-2200, manufactured by SHIMADZU CORPORATION) is used as a measurement apparatus, and Wing SALD-2200 is used as a measurement control software.

As a measurement technique, a measurement mode of scattering type is employed. A measurement wet cell containing a dispersion obtained by dispersing the non-graphitizable carbon in a dispersive solvent is placed under an ultrasonic wave environment for 5 minutes, set in the laser diffraction particle size distribution measurement apparatus, and then is measured by laser light irradiation to obtain a distribution of scattered light. The obtained distribution of scattered light is approximated by a log-normal distribution, and a particle size which corresponds to a cumulative degree of 50% (D50) in a particle size range set to 0.1 μm as a minimum and to 100 μm as a maximum in the particle size distribution (horizontal axis, σ), is defined as an average particle size.

Incidentally, it is not excluded that the graphite or the non-graphitizable carbon contains a small amount of representative nonmetal elements such as B, N, P, F, Cl, Br, and I, a small amount of representative metal elements such as Li, Na, Mg, Al, K, Ca, Zn, Ga, and Ge, and a small amount of transition metal elements such as Sc, Ti, V, Cr, Mn, Fe, Co, Ni, Cu, Mo, Zr, Ta, Hf, Nb, and W within a range that does not impair the effect of the present invention.

Furthermore, the negative electrode for a nonaqueous electrolyte energy storage device may contain an active material other than the graphite and the non-graphitizable carbon.

A binder to be used for the negative electrode for a nonaqueous electrolyte energy storage device, an aqueous binder is used.

The aqueous binder can be defined as a binder capable of using an aqueous solvent in preparing a composite (electrode paste). More specifically, the aqueous binder can be defined as a binder capable of using water or a mixed solvent predominantly composed of water as a solvent in being mixed with an active material to form a paste. As such a binder, non-organic solvent type various polymers can be used.

As the aqueous binder, it is preferred to use at least one selected from rubber-based polymers and resin-based polymers capable of being dissolved or dispersed in the aqueous solvent. Herein, the aqueous solvent refers to water or a mixed solvent predominantly composed of water. As a solvent, other than water, constituting the mixed solvent, organic solvents which can be uniformly mixed with water (lower alcohols, lower ketones, etc.), can be exemplified.

As the rubber-based polymers capable of being dissolved or dispersed in the aqueous solvent, a styrene-butadiene rubber (SBR), an acrylonitrile-butadiene rubber (NBR), a methyl methacrylate-butadiene rubber (MBR), and the like can be exemplified. These polymers can be preferably used as a binder in a state of being dissolved in water. That is, examples of usable aqueous binder include a water dispersion of a styrene-butadiene rubber (SBR), a water dispersion of an acrylonitrile-butadiene rubber (NBR), a water dispersion of a methyl methacrylate-butadiene rubber (MBR), and the like. Among these rubber-based polymers capable of being dissolved or dispersed in the aqueous solvent, the styrene-butadiene rubber (SBR) is preferably used.

Examples of the resin-based polymers capable of being dissolved or dispersed in the aqueous solvent include acrylic resins, olefinic resins, fluorine-based resins, nitrile-based resins and the like. Examples of the acrylic resins include acrylic acid esters, methacrylic acid esters and the like. Examples of the olefinic resins include polypropylene (PP), polyethylene (PE) and the like. Examples of the fluorine-based resins include polytetrafluoroethylene (PTFE), hydrophilic polyvinylidene fluoride (PVDF) and the like. Examples of the nitrile-based resins include polyacrylonitrile (PAN) and the like.

Further, as the aqueous binder, a copolymer containing two or more monomers can also be used. Examples of such a copolymer include an ethylene-propylene copolymer, an ethylene-methacrylic acid copolymer, an ethylene-acrylic acid copolymer, a propylene-butene copolymer, an acrylonitrile-styrene copolymer, a methylmethacrylate-butadiene-styrene copolymer and the like.

As the aqueous binder, a polymer in which a functional group is introduced by modification or a polymer having a crosslinked structure can also be used.

The aqueous binder preferably has a. glass-transition temperature (Tg) of −30° C. or higher and 50° C. or lower since flexibility of the negative electrode for a nonaqueous electrolyte energy storage device is improved while maintaining problem-free adhesion during manufacturing or processing a plate.

The additive amount of the aqueous binder is preferably 0.5 to 50% by mass, more preferably 1 to 30% by mass, and particularly preferably 1 to 10% by mass with respect to a total mass of the negative composite layer of the negative electrode for a nonaqueous electrolyte energy storage device. As the aqueous binder, the above-mentioned polymers can be used singly or in combination of a plurality of the polymers.

The negative electrode for a nonaqueous electrolyte energy storage device may include a thickener. Examples of the thickener include starch-based polymers, alginic acid-based polymers, microorganism-based polymers, cellulose-based polymers and the like.

Here, the cellulose-based polymers can be classified into nonionic polymers, cationic polymers and anionic polymers. Examples of the nonionic cellulose-based polymers include alkyl cellulose, hydroxyalkyl cellulose and the like.

Examples of the cationic cellulose-based polymers include chlorinated o-[2-hydroxy-3-(trimethylammonio)propyl]hydroxyethyl cellulose (polyquaternium-10) and the like. Examples of the anionic cellulose-based polymers include alkyl celluloses having a structure represented by the following general formula (1) or general formula (2) formed by substituting the nonionic cellulose-based polymers with various derivative groups, and metallic salts or ammonium salts thereof.

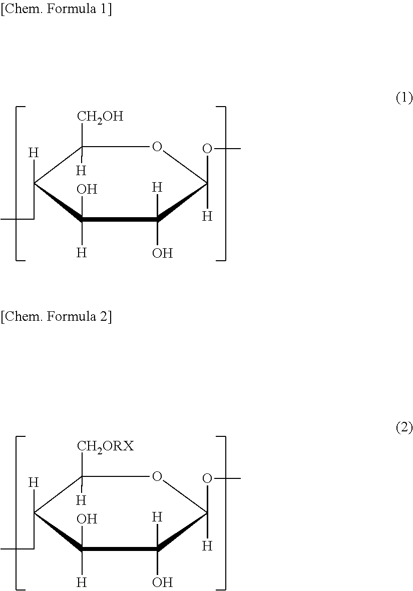

In the above general formula, X is preferably an alkali metal, NH4, or H. R is preferably a divalent hydrocarbon group. The number of carbon atoms of the hydrocarbon group is not particularly limited; however, it is usually about 1 to 5. Furthermore, R may be a hydrocarbon group or an alkylene group which contains a carboxy group or the like.

Specific examples of the anionic cellulose-based polymers include carboxymethyl cellulose (CMC) methyl cellulose (MC), hydroxypropyl methyl cellulose (HPMC), sodium cellulose sulfate, methyl cellulose, methyl ethyl cellulose, ethyl cellulose, and salts thereof. Among these celluloses, carboxymethyl cellulose (CMC), methyl cellulose (MC), and hydroxypropyl methyl cellulose (HPMC) are preferred, and carboxymethyl cellulose (CMC) is more preferred.

A degree of substitution of a substitute such as a carboxymethyl group for hydroxy groups (three groups) per anhydroglucose unit in the cellulose, is referred to as a degree of etherification, and the degree of etherification can theoretically assume a value of 0 to 3. A smaller etherification degree shows that the hydroxy group in the cellulose increases and the substitute decreases. In the present invention, a degree of etherification of cellulose as the thickener contained in the negative composite layer is preferably 1.5 or less, more preferably 1.0 or less, furthermore preferably 0.8 or less.

In the embodiment of the present invention, it is preferred to set a ratio of the mass of the non-graphitizable carbon to a total mass of the graphite and the non-graphitizable carbon to 10% by mass or more and 30% by mass or less.

Thereby, an energy density can be increased while keeping DC resistance at low temperatures of the negative electrode for a nonaqueous electrolyte energy storage device low, thus being preferred.

Furthermore, it is more preferred to set a ratio of the mass of the non-graphitizable carbon to a total mass of the graphite and the non-graphitizable carbon to 10% by mass or more and 20% by mass or less.

Thereby, resistance to high-temperature storage of the negative electrode for a nonaqueous electrolyte energy storage device can be enhanced, as shown in Examples described later.

In the embodiment of the present invention, an average particle size of the non-graphitizable carbon is preferably smaller than that of the graphite. Thereby, DC resistance at low temperatures of the negative electrode for a nonaqueous electrolyte energy storage device can be more reduced, thus being preferred.

Further, in the embodiment of the present invention, the average particle size of the non-graphitizable carbon is set to preferably 2 μm or more and 4 μm or less, more preferably 2.5 μm or more and 4 μm or less, and particularly preferably 3 μm or more and 4 μm or less. Since by this constitution, the non-graphitizable carbon efficiently distributes into clearance between graphite particles in mixing the graphite and the non-graphitizable carbon, DC resistance at low temperatures of the negative electrode for a nonaqueous electrolyte energy storage device can be more reduced, thus being preferred.

In the embodiment of the present invention, the non-graphitizable carbon preferably has a crystal structure not exhibiting orientation toward a specific one axis direction. Since a site which performs the absorption and release of lithium ions is increased by having the crystal structure not exhibiting orientation toward a specific one axis direction, input power/output power performance of the negative electrode for a nonaqueous electrolyte energy storage device is improved, thus being preferred. Further, since the crystal is hardly oriented in a thickness direction of the negative composite layer in the negative composite layer, expansion/contraction of the negative composite layer is suppressed during charge-discharge to improve cycle performance of the nonaqueous electrolyte energy storage device, thus being preferred.

In the embodiment of the present invention, a particle shape of the non-graphitizable carbon is preferably made to be non-spherical. Thereby, dispersibility of the graphite and the non-graphitizable carbon in the negative composite layer can be enhanced, resulting in a higher contact ratio between the graphite and the non-graphitizable carbon, and therefore the DC resistance at low temperatures of the negative electrode for a nonaqueous electrolyte energy storage device can be further reduced, thus being preferred.

Herein, whether the particle shape of the non-graphitizable carbon is non-spherical or not is determined by a ratio of the longest diameter (major axis) to the shortest diameter (minor axis) of the non-graphitizable carbon particle. Specifically, a shape satisfying a relation of b/a≤0.85 is considered as non-spherical when the major axis of the non-graphitizable carbon particle is denoted by a, and the minor axis is denoted by b.

The negative electrode for a nonaqueous electrolyte energy storage device is suitably prepared by adding and kneading a negative active material containing graphite and non-graphitizable carbon, an aqueous binder, a thickener and an aqueous solvent such as water to form a negative electrode paste, applying the negative electrode paste onto a current collector such as a copper foil and subjecting the paste to a heating treatment at a temperature of about 50° C. to 250° C. The application method is preferably carried out to give an arbitrary thickness and an arbitrary shape by using a means such as roller coating of an applicator roll or the like, screen coating, doctor blade coating manner, spin coating, bar coater, and die coater; however it is not limited to thereto.

The negative electrode paste may contain a conductive agent. Further, the negative electrode paste need not contain a thickener.

The negative electrode for a nonaqueous electrolyte energy storage device preferably has the thickness of the negative composite layer of 30 μm or more and 120 μm or less, and the porosity of the negative composite layer of 15% or more and 40% or less from the viewpoint of charge-discharge characteristics.

From the viewpoint of enhancing the safety of the nonaqueous electrolyte energy storage device, the negative electrode for a nonaqueous electrolyte energy storage device may include a covering layer containing fillers on the negative composite layer.

As the filler, an inorganic oxide which is electrochemically stable even at a negative electrode potential of a nonaqueous electrolyte energy storage device in a state of full-charge, is preferred. Furthermore, from the viewpoint of enhancing heat resistance of the covering layer, an inorganic oxide having heat resistance of 250° C. or higher is more preferred. Examples thereof include alumina, silica, zirconia, titania and the like. Among these inorganic oxides, alumina and titania are particularly preferred. The particle diameter (modal diameter) of the filler is preferably 0.1 μm or more.

The above-mentioned fillers may be used singly or may be used as a mixture of two or more thereof.

The thickness of the covering layer is preferably 0.1 μm or more and 30 μm or less from the viewpoint of an energy density of the nonaqueous electrolyte energy storage device. Furthermore, the thickness of the covering layer is more preferably 1 μm or more and 30 μm or less from the viewpoint of improvement of reliability of the nonaqueous electrolyte energy storage device, and particularly preferably 1 μm or more and 10 μm or less from the viewpoint of charge-discharge characteristics of the nonaqueous electrolyte energy storage device.

Examples of a binder for the covering layer include the following compounds; however, the binder is not limited to these compounds.

For example, fluorine resins such as polyvinylidene fluoride PVDF), polytetrafluoroethylene (PTFE) and a tetrafluoroethylene-hexafluoropropylene copolymer (FEP), polyacrylic acid derivatives, polyacrylonitrile derivatives, polyethylene, rubber-based binders such as a styrene-butadiene rubber, polyacrylonitrile derivatives and the like are exemplified.

Examples of a material of the current collector, such as a current collecting foil, to be used for the negative electrode for a nonaqueous electrolyte energy storage device, include metal materials such as copper, nickel, stainless steel, nickel-plated steel and chromium-plated steel. Among these materials, copper is preferred from the viewpoint of ease of processing, cost and electric conductivity.

The positive active material is not particularly limited as long as it is higher in reversible potential associated with charge-discharge than the negative active material. Examples of the positive active material include lithium transition metal composite oxides such as LiCoO₂, LiMn₂O₄, LiNiₓCo₁₋ₓO₂, Li_{w}NiₓMn_{y}Co_{1-x-y}O₂, Li(Ni_{0.5}Mn_{1.5})O₄, Li₄Ti₅O₁₂ and LiV₃O₈; lithium excessive type transition metal composite oxides such as Li[LiₐNiₓMn_{y}Co_{1-a-x-y}]O₂; polyanion compounds such as LiFePO₄, LiMnPO₄, Li₃V₂(PO₄)₃ and Li₂MnSiO₄; iron sulfide, iron fluoride, sulfur, and the like.

A nonaqueous electrolyte energy storage device obtained by combining a positive electrode for a nonaqueous electrolyte energy storage device which particularly uses the lithium transition metal composite oxide represented by the formula LiₓNiₓMn_{y}Co_{1-x-y}O₂ (0<w≤1.2, 0<x≤1, 0≤y<1) as a main component of the positive active material with the negative electrode for a nonaqueous electrolyte energy storage device of the embodiment of the present invention, is preferred. The reason for this is that the nonaqueous electrolyte energy storage device has an excellent balance of an energy density, charge-discharge characteristics and life performance such as high temperature storage, and the effect of the present invention is high. Incidentally, using the lithium transition metal composite oxide as a main component of the positive active material means that a mass of the lithium transition metal composite oxide represented by the formula Li_{w}NiₓMn_{y}Co_{1-x-y}O₂ is the largest in an entire mass of the positive active material.

The higher the proportion of the number of moles x of nickel in Li_{w}NiₓMn_{y}Co_{1-x-y}O₂ is, the more an increase in DC resistance between before storage and after storage at high temperature of the nonaqueous electrolyte energy storage device can be suppressed, thus being preferred. Therefore, x preferably satisfies a relation of x>0.3, and more preferably satisfies a relation of x≥0.33.

Meanwhile, when x satisfies a relation of x>0.8, initial coulombic efficiency of the Li_{w}NiₓMn_{y}CO_{1-x-y}O₂ tends to be lowered.

From these viewpoints, x in Li_{w}NiₓMn_{y}Co_{1-x-y}O₂ preferably satisfies a relation of x>0.3, more preferably satisfies a relation of x≥0.33, and particularly satisfies a relation of 0.33≤x≤0.8.

The positive electrode for a nonaqueous electrolyte energy storage device is suitably prepared by adding and kneading a positive active material, a conductive agent, a binder and an organic solvent such as N-methylpyrrolidone or toluene or water to form a paste, applying the paste onto a current collector such as an aluminum foil and subjecting the paste to a heating treatment at a temperature of about 50° C. to 250° C. The application method is preferably carried out to give an arbitrary thickness and an arbitrary shape by using a means such as roller coating of an applicator roll or the like, screen coating, doctor blade coating manner, spin coating, and bar coater; however it is not limited to thereto.

In the embodiment of the present invention, the nonaqueous electrolyte is not particularly limited, and those generally proposed for use for lithium batteries, lithium ion capacitors and the like can be used.

Examples of nonaqueous solvents to be used for the nonaqueous electrolyte include, but not limited to, one compound or a mixture of two or more of compounds of cyclic carbonate esters such as propylene carbonate, ethylene carbonate, and vinylene carbonate; cyclic esters such as γ-butyrolactone; chain carbonates such as dimethyl carbonate, diethyl carbonate, and ethylmethyl carbonates; chain esters such as methyl acetate; tetrahydrofuran and derivatives thereof; ethers such as 1,3-dioxane, 1,4-dioxane, and methyl diglyme; nitriles such as acetonitrile; dioxolan and derivatives thereof; and ethylene sulfide, sulfolane, sultone and derivatives thereof.

Examples of an electrolyte salt to be used for the nonaqueous electrolyte include inorganic ion salts having one of lithium (Li), sodium (Na) and potassium (K), such as LiClO₄, LiBF₄, LiPF₆, NaClO₄, NaSCN, KClO₄, and KSCN; and organic ion salts such as LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, (CH₃)₄NBF₄, (C₂H₅)₄N-benzoate, lithium stearylsulfonate and lithium dodecylbenzenesulfonate; and these ionic compounds can be used singly or in combination of two or more thereof.

Further, by mixing LiPF₆ or LiBF₄ with a lithium salt having a perfluoroalkyl group, such as LiN(C2F₅SO₂)₂, the viscosity of the electrolyte can be further reduced, and therefore the low-temperature performance can be further improved, and self-discharge can be suppressed, thus being more preferable.

Further, an ambient temperature molten salt or an ion liquid may be used as a nonaqueous electrolyte.

The concentration of the lithium ion (Li³⁰ ) in the nonaqueous electrolyte solution is preferably 0.1 mol/l to 5 mol/l, still more preferably 0.5 mol/l to 2.5 mol/l, and particularly preferably 0.8 mol/l to 1.0 mol/l for obtaining a nonaqueous electrolyte energy storage device having high charge-discharge characteristics.

In the embodiment of the present invention, as a separator, it is preferred that a porous membrane, a nonwoven fabric or the like, which shows excellent high rate discharge performance, be used singly or in combination. Examples of a material constituting the separator include polyolefin-based resins typified by polyethylene, polypropylene and the like, polyester-based resins typified by polyethylene terephthalate and the like, polyvinylidene fluoride, a vinylidene fluoride copolymer, various amide-based resins, various celluloses, polyethylene oxide-based resins, and the like.

Further, examples of the material constituting the separator include a polymer gels formed of a polymer, such as acrylonitrile, ethylene oxide, propylene oxide, methyl methacrylate, vinyl acetate, vinyl pyrrolidone or polyvinylidene fluoride, and a nonaqueous electrolyte.

Furthermore, when the above-mentioned porous membrane, nonwoven fabric or the like is used in combination with the polymer gel as a separator, this improves the liquid retainability of the nonaqueous electrolyte, thus being preferable. That is, the surface and the micropore wall surface of a polyethylene microporous film are covered with a solvent-compatible polymer having a thickness of several micrometers or less to form a film, and a nonaqueous electrolyte is retained into the micropores of the film, whereby the solvent-compatible polymer gelates.

Examples of the solvent-compatible polymer include, in addition to polyvinylidene fluoride, polymers in which an acrylate monomer having an ethylene oxide group, an ester group or the like, an epoxy monomer, a monomer having an isocyanate group, or the like is crosslinked. The monomer can be subjected to a crosslinking reaction by carrying out heating or using ultraviolet rays (UV) in combination with a radical initiator, or by using active light rays such as electron beams (EB) or the like.

Further, a surface layer containing inorganic fillers may be disposed on the surface of the separator. When a separator including the surface layer containing inorganic fillers is used, thermal shrinkage of the separator is suppressed, and therefore internal short-circuit can be mitigated or prevented even though the nonaqueous electrolyte energy storage device reaches a temperature higher than a normal operating temperature region. Therefore, safety of the nonaqueous electrolyte energy storage device of the present invention can be more improved, thus being preferred.

Examples of the inorganic filler include inorganic oxides, inorganic nitrides, hardly soluble ion-binding compounds, covalent compounds, clay of montmorillonite, and the like.

Examples of the inorganic oxides include iron oxide, silica (SiO₂), alumina (Al₂O₃), titanium oxide (TiO₂), barium titanate (BaTiO₃), zirconium oxide (ZrO₂), and the like.

Examples of the inorganic nitrides include aluminum nitride, silicon nitride, and the like.

Examples of the hardly soluble ion-binding compounds include calcium fluoride, barium fluoride, barium sulfate, and the like.

Furthermore, when the surface layer containing inorganic fillers is arranged so as to be opposed to the positive electrode in configuring a nonaqueous electrolyte energy storage device, the safety of the nonaqueous electrolyte energy storage device of the embodiment of the present invention can be further improved, thus being more preferred.

The porosity of the separator is preferably 98 vol % or less from the viewpoint of the strength of the separator. Further, the porosity is preferably 20 vol % or more from the viewpoint of charge-discharge characteristics.

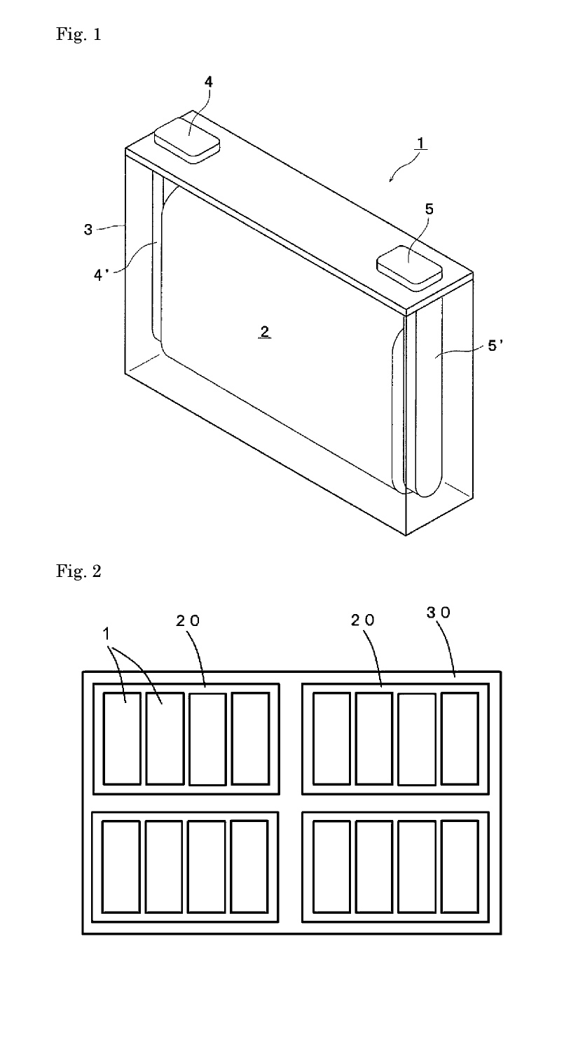

FIG. 1 shows a schematic view of a rectangular nonaqueous electrolyte energy storage device 1 of an embodiment of the nonaqueous electrolyte energy storage device according to the present invention. FIG. 1 is a perspective view of the inside of a container. In the nonaqueous electrolyte energy storage device 1 shown in FIG. 2, an electrode group 2 is housed in an outer case 3. The electrode group 2 is configured by winding a positive electrode including a positive active material and a negative electrode including a negative active material with a separator interposed therebetween. The positive electrode is electrically connected to a positive electrode terminal 4 through a positive electrode lead 4′, and the negative electrode is electrically connected to a negative electrode terminal 5 through a negative electrode lead 5′. The nonaqueous electrolyte is held inside the outer case and within the separator.

The configuration of the nonaqueous electrolyte energy storage device according to the present invention is not particularly limited, and examples thereof include a cylindrical, a prismatic (rectangular) and a flat nonaqueous electrolyte energy storage devices.

The present invention can also be realized as an energy storage apparatus having a plurality of the nonaqueous electrolyte energy storage devices. An embodiment of the energy storage apparatus is shown in FIG. 2. In FIG. 2, the energy storage apparatus 30 includes a plurality of energy storage units 20. Each of the energy storage units 20 includes a plurality of nonaqueous electrolyte energy storage devices 1. The energy storage apparatus 30 can be mounted as a power source for automobiles such as electric vehicles (EV), hybrid automobiles (HEV) and plug-in hybrid automobiles (PHEV).

In Examples described later, a lithium ion secondary battery will be exemplified as a nonaqueous electrolyte energy storage device; however, the present invention is not applicable only to the lithium ion secondary battery and applicable to other nonaqueous electrolyte energy storage devices.

### EXAMPLE 1

(Preparation of Negative Electrode)

A negative electrode paste was prepared using graphite, non-graphitizable carbon (average particle size: 3.5 μm, b/a=0.8, d(002)=0.37 nm), a styrene-butadiene rubber (SBR) serving as a binder, carboxymethyl cellulose (CMC) and water serving as a solvent. A mass ratio between the graphite and the non-graphitizable carbon was set to 90:10, and a mass ratio among a total of the graphite and the non-graphitizable carbon, the SBR and the CMC was set to 96:2:2.

The negative electrode paste was prepared by adjusting an amount of water to adjust a solid content (% by mass), and undergoing a kneading step using a multi blender mill. The negative electrode paste was intermittently applied onto both surfaces of a copper foil leaving an unapplied portion (region in which a negative composite layer was not formed) and dried, and thereby a negative composite layer was prepared.

After preparing the negative composite layer as described above, roll pressing was carried out in such a way that the thickness of the negative composite layer was 70 μm.

(Preparation of Positive Electrode)

A positive electrode paste was prepared using lithium-cobalt-nickel-manganese composite oxide (LiCo_{1/3}Ni_{1/3}Mn_{1/3}O₂) serving as a positive active material, acetylene black (AB) serving as a conductive agent, polyvinylidene fluoride (PVDF) serving as a binder and N-methylpyrrolidone (NMP) serving as a nonaqueous solvent. Here, a 12% NMP solution (#1100 produced by Kureha Chemical Industry Co., Ltd.) was used as the PVDF. Incidentally a mass ratio among the positive active material, the binder and the conductive agent was set to 90:5:5 (solid content basis). The positive electrode paste was intermittently applied onto both surfaces of an aluminum foil leaving an unapplied portion (region in which a positive composite layer was not formed) and dried. Thereafter, roll pressing was carried out to prepare a positive electrode.

(Nonaqueous Electrolyte Solution)

A nonaqueous electrolyte was prepared by dissolving LiPF₆ so that a salt concentration was 1.2 mol/L in a solvent formed by mixing 30 vol % of ethylene carbonate, 40 vol % of dimethyl carbonate and 30 vol % of ethyl methyl carbonate. A water content in the nonaqueous electrolyte is adjusted to less than 50 ppm.

(Separator)

For a separator, a polyethylene microporous membrane having a thickness of 21 μm was used.

(Assembling of Battery)

The positive electrode, the negative electrode, and the separator were superimposed and wound. Thereafter, a region of the positive electrode in which the positive composite layer was not formed and a region of the negative electrode in which the negative composite layer was not formed were welded to a positive electrode lead and a negative electrode lead, respectively, and enclosed in a container. After welding a lid to the container, the nonaqueous electrolyte was injected and the container opening was sealed. A battery of Example 1 was prepared in this way.

### EXAMPLE 2

A battery of Example 2 was prepared in the same manner as in Example 1 except for changing the mass ratio between the graphite and the non-graphitizable carbon to 80:20.

### EXAMPLE 3

A battery of Example 3 was prepared in the same manner as in Example 1 except for changing the mass ratio between the graphite and the non-graphitizable carbon to 70:30.

### EXAMPLE 4

A battery of Example 4 was prepared in the same manner as in Example 1 except for changing the mass ratio between the graphite and the non-graphitizable carbon to 50:50.

### COMPARATIVE EXAMPLE 1

A battery of Comparative Example 1 was prepared in the same manner as in. Example 1 except for changing the mass ratio between the graphite and the non-graphitizable carbon to 100:0.

### COMPARATIVE EXAMPLE 2

A battery of Comparative Example 2 was prepared in the same manner as in Example 1 except for changing the average particle size of the non-graphitizable carbon (d(002)=0.37 nm) to 9 μm.

### COMPARATIVE EXAMPLE 3

A battery of Comparative Example 3 was prepared in the same manner as in Example 1 except for using the graphitizable carbon (average particle size: 15 μm, d(002)=0.345 nm) in place of the non-graphitizable carbon.

(Capacity Measurement)

Each of batteries of Examples 1 to 4 and Comparative Examples 1 to 3 thus prepared was subjected to the following capacity measurement in a thermostatic oven set at 25° C., and it was verified that charge-discharge having an electric quantity equal to a nominal capacity of a battery is possible.

With respect to charge conditions of the capacity measurement, constant current constant voltage charge with a current value of 1 CA and a voltage of 4.2 V, was employed. A charge time was set to 3 hours from a start of charge. With respect to discharge conditions of the capacity measurement, constant current discharge with a current value of 1 CA and an end voltage of 2.75 V was employed. A quiescent time of 10 minutes was provided between charge and discharge.

Incidentally the above-mentioned 1 CA which is a current value refers to a current value at which constant current carrying of a battery is performed for 1 hour and an electric quantity becomes the same as a nominal capacity of the battery.

(Measurement of DC Resistance at Low Temperature)

After the capacity measurement, constant current constant voltage charge with a current value of 0.1 CA and a voltage of 4.2 V was carried out. A charge time was set to 15 hours from a start of charge. After the quiescent of 10 minutes, constant current discharge was carried out at a current value of 0.1 CA. Discharge was stopped at the moment of passing an electric quantity of 50% of the nominal capacity of the battery.

Each battery was transferred to a thermostatic oven set at −10° C. and left standing for 5 hours.

Thereafter, a test, in which discharge is carried out for 10 seconds at a discharge current at each rate, was performed. Specifically discharge was carried out at a current of 0.2 CA for 10 seconds first, and supplementary charging was carried out at a current of 0.2 CA. for 10 seconds after quiescent of 2 minutes. Furthermore, after quiescent of 2 minutes, discharge was carried out at a current of 0.5 CA for 10 seconds, and after quiescent of 2 minutes, supplementary charging was carried out at a current of 0.2 CA for 25 seconds. Furthermore, after quiescent of 2 minutes, discharge was carried out at a current of 1 CA for 10 seconds As the above-mentioned results, voltages at 10 seconds after discharge at each rate were plotted with respect to current values at the discharge at each rate, these plotted pointed were approximated by a regression line (graph) based on a least square method, and a DC resistance value was calculated from a slope of the line.

When the DC resistance value of the battery of Comparative Example 1 was taken as 100%, a value which is calculated as a relative value of a DC resistance value of each battery to the DC resistance value of the battery of Comparative Example 1, was shown in Table 1 as “Relative Value of DC Resistance”.

TABLE 1

| | | Average Particle Size | Mass Ratio | |
|---|---|---|---|---|
| | | of Non-graphitizable | (Graphite:Non- | Relative Value |
| | | Carbon | graphitizable | of DC |
| | Negative Electrode | (μm) | Carbon) | Resistance |
| Example 1 | Graphite + | 3.5 | 90:10 | 89% |
| | Non-graphitizable Carbon | | | |
| Example 2 | Graphite + | 3.5 | 80:20 | 83% |
| | Non-graphitizable Carbon | | | |
| Example 3 | Graphite + | 3.5 | 70:30 | 80% |
| | Non-graphitizable Carbon | | | |
| Example 4 | Graphite + | 3.5 | 50:50 | 69% |
| | Non-graphitizable Carbon | | | |
| Comparative | Graphite | — | 100:0 | 100% |
| Example 1 | | | | |
| Comparative | Graphite + | 9 | 90:10 | 102% |
| Example 2 | Non-graphitizable Carbon | | | |
| Comparative | Graphite + Easily | — | 90:10 | 104% |
| Example 3 | Graphitizable Carbon | | | |

### EXAMPLE 5

A battery of Example 5 was prepared in the same manner as in Example 1 except for changing the mass ratio between the graphite and the non-graphitizable carbon to 85:15.

### COMPARATIVE EXAMPLE 4

(Preparation of Negative Electrode)

A negative electrode paste was prepared using graphite, non-graphitizable carbon (average particle size: 3.5 μm, b/a=0.8, d(002)=0.37 nm), polyvinylidene fluoride (PVDF) serving as a binder and N-methylpyrrolidone (NMP) serving as a solvent. A mass ratio between the graphite and the non-graphitizable carbon was set to 90:10, and a mass ratio between a total of the graphite and the non-graphitizable carbon and the binder was set to 92:8.

The negative electrode paste was prepared by adjusting an amount of NMP to adjust a solid content (% by mass), and undergoing a kneading step using a multi blender mill. The negative electrode paste was applied onto both surfaces of a copper foil leaving an unapplied portion (region in which a negative composite layer was not formed) and dried, and thereby a negative composite layer was prepared.

After preparing the negative composite layer as described above, roll pressing was carried out in such a way that the thickness of the negative composite layer was 70 μm.

A battery of Comparative Example 4 was prepared in the same manner as in Example 1 except for using a negative electrode thus prepared.

### COMPARATIVE EXAMPLE 5

A battery of Comparative Example 5 was prepared in the same manner as in Comparative Example 4 except for changing the mass ratio between the graphite and the non-graphitizable carbon to 85:15.

### COMPARATIVE EXAMPLE 6

A battery of Comparative Example 6 was prepared in the same manner as in Comparative Example 4 except for changing the mass ratio between the graphite and the non-graphitizable carbon to 80:20.

(Capacity Measurement)

Each of batteries of Example 1, Example 2, Example 5 and Comparative Examples 4 to 6 thus prepared was subjected to the following capacity measurement in a thermostatic oven set at 25° C., and it was verified that charge-discharge having an electric quantity equal to a nominal capacity of a battery is possible.

With respect to charge conditions of the capacity measurement, constant current constant voltage charge with a current value of 1 CA and a voltage of 4.2 V, was employed. A charge time was set to 3 hours from a start of charge. With respect to discharge conditions of the capacity measurement, constant current discharge with a current value of 1 CA and end voltage of 2.75 V was employed. A quiescent time of 10 minutes was provided between charge and discharge,

Incidentally, the above-mentioned 1 CA which is a current value refers to a current value at which constant current carrying of a battery is performed for 1 hour and an electric quantity becomes the same as a nominal capacity of the battery.

(Measurement of DC Resistance Before Storage)

After the capacity measurement, constant current constant voltage charge with a current value of 0.1 CA and a voltage of 4.2 V was carried out. A charge time was set to 15 hours from a start of charge. After the quiescent of 10 minutes, constant current discharge was carried out at a current value of 0.1 CA. Discharge was stopped at the moment of passing an electric quantity of 50% of the nominal capacity of the battery.

Each battery was transferred to a thermostatic oven set at −10° C. and left standing for 5 hours.

Thereafter, a test, in which discharge is carried out for 10 seconds at a discharge current at each rate, was performed. Specifically, discharge was carried out at a current of 0.2 CA for 10 seconds first, and supplementary charging was carried out at a current of 0.2 CA for 10 seconds after quiescent of 2 minutes. Furthermore, after quiescent of 2 minutes, discharge was carried out at a current of 0.5 CA 10 seconds, and after quiescent of 2 minutes, supplementary charging was carried out at a current of 0.2 CA for 25 seconds. Furthermore, after quiescent of 2 minutes, discharge was carried out at a current of 1 CA for 10 seconds As the above-mentioned results, voltages at 10 seconds after discharge at each rate were plotted with respect to current values at the discharge at each rate, these plotted pointed were approximated by a regression line (graph) based on a least square method, and a DC resistance value was calculated from a slope of the line. The DC resistance value was defined as “DC resistance value before storage”.

(High-Temperature Storage Step)

After the measurement of DC resistance at low temperatures, constant current discharge with a current value of 1 CA and an end voltage of 2.75 V was carried out. After quiescent of 10 minutes, constant current constant voltage charge with a charge current value of 1 CA and a voltage of 4.2 V was carried out. A charge time was set to 3 hours from a start of energization. The charged battery was transferred to a thermostatic oven set at 60° C. and stored for 25 days.

(Measurement of DC Resistance After Storage)

The battery after the high-temperature storage step was transferred to a thermostatic oven set at 25° C. and left standing for 1 day.

Thereafter, constant current discharge with a current value of 1 CA and an end voltage of 2.75 V was carried out.

Thereafter, the DC resistance value after the high-temperature storage was measured by the same step as in Measurement of DC Resistance before Storage. The DC resistance value in doing so is defined as “DC resistance value after storage”.

With respect to “DC resistance value before storage” and “DC resistance value after storage” measured in each of batteries of Example 1, Example 2, Example 5 and Comparative Examples 4 to 6, a value calculated based on the following formula was recorded in Table 2 as “DC resistance decrease rate”.

“DC resistance decrease rate”=(“DC resistance value before storage”−“DC resistance value after storage”)/“DC resistance value before storage”

TABLE 2

| | | | Mass Ratio | |
|---|---|---|---|---|
| | | | (Graphite:Non- | |
| | | | graphitizable | DC Resistance |
| | Negative Electrode | Binder | Carbon) | Decrease Rate |
| Example 1 | Graphite + | Aqueous Binder | 90:10 | 26% |
| | Non-graphitizable Carbon | (SBR) | | |
| Example 5 | Graphite + | Aqueous Binder | 85:15 | 25% |
| | Non-graphitizable Carbon | (SBR) | | |
| Example 2 | Graphite + | Aqueous Binder | 80:20 | 26% |
| | Non-graphitizable Carbon | (SBR) | | |
| Comparative | Graphite + | Nonaqueous Binder | 90:10 | 21% |
| Example 4 | Non-graphitizable Carbon | (PVDF) | | |
| Comparative | Graphite + | Nonaqueous Binder | 85:15 | 19% |
| Example 5 | Non-graphitizable Carbon | (PVDF) | | |
| Comparative | Graphite + | Nonaqueous Binder | 80:20 | 16% |
| Example 6 | Non-graphitizable Carbon | (PVDF) | | |

As is apparent from Table 1, the relative values of DC resistance of the batteries of Examples 1 to 4 in which the graphite and the non-graphitizable carbon having an average particle size of 8 μm or less were used, were smaller than that of the battery of Comparative Example 1 not using the non-graphitizable carbon. That is, the relative values of DC resistance of the batteries of Examples 1 to 4 were smaller than that of the battery of Comparative Example 1, resulting in lower DC resistance than Comparative Example 1. From this, the DC resistance at low temperatures of the battery and the negative electrode can be reduced by allowing the graphite and the non-graphitizable carbon having an average particle size of 8 μm or less to coexist.

On the other hand, the relative value of DC resistance of the battery of Comparative Example 2 in which the graphite and the non-graphitizable carbon having an average particle size of 9 μm were used, was larger than that of Comparative Example 1. That is, the DC resistance value of the battery of Comparative Examples 2 was larger than that of the battery of Comparative Example 1, resulting in a larger DC resistance than Comparative Example 1. From this, it is found that the effect of reducing the DC resistance at low temperatures of the battery and the negative electrode cannot be achieved even though the non-graphitizable carbon having an average particle size larger than 8 μm is used.

Also, the relative value of DC resistance of the battery of Comparative Example 3 in which the graphite and the graphitizable carbon were used, was larger than that of Comparative Example 1. That is, the DC resistance value of the battery of Comparative Examples 3 was larger than that of the battery of Comparative Example 1, resulting in a larger DC resistance than. Comparative Example 1. From this, it is found that the effect of reducing the DC resistance at low temperatures of the battery and the negative electrode cannot also be achieved when the easily graphitizable carbon is used.

When the graphite and the non-graphitizable carbon having an average particle size of 8 μm or less were used like Examples 1 to 4, it is thought that since the non-graphitizable carbon distributes into clearance between graphite particles in mixing the graphite and the non-graphitizable carbon, a packing property of a layer of a negative electrode composite for a nonaqueous electrolyte energy storage device is improved, resulting in an improvement of a current collecting property of the negative composite layer, and therefore the DC resistance at low temperatures of the battery and the negative electrode can be reduced.

On the other hand, when the average particle size of the non-graphitizable carbon is more than 8 μm, it is thought that since an amount of the non-graphitizable carbon penetrating into clearance between graphite particles is too small, a packing property of a layer of a negative electrode composite for a nonaqueous electrolyte energy storage device is not improved and a current collecting property of the negative composite layer is hardly improved. Therefore, the effect of reducing the DC resistance at low temperatures of the battery and the negative electrode is not achieved.

As is apparent from Table 2, the DC resistance decrease rate of the battery of Example 1 using the aqueous binder in the negative electrode in which the graphite and the non-graphitizable carbon having an average particle size of 8 μm or less were used, was larger than that of the battery of Comparative Example 4 using the nonaqueous solvent-based binder in the same negative electrode. That is, it is possible to more enhance a DC resistance decrease rate at low temperatures of the battery and the negative electrode by employing the aqueous binder on the negative electrode.

The high “DC resistance decrease rate” indicates that the effect acting a direction of reducing the DC resistance of a battery is high when storing the battery at high temperatures. Therefore, it is supposed that an increasing amount of the DC resistance can be suppressed even in a battery in which the DC resistance is increased due to the storage at high temperature.

Also, in comparison between Example 5 and Comparative Example 5 and between Example 2 and Comparative Example 6, the batteries of Examples have higher DC resistance decrease rate than the batteries of Comparative Examples. From this, it is found that the DC resistance decrease rate at low temperatures of the battery and the negative electrode is enhanced by employing the aqueous binder on the negative electrode even when the ratio of the mass of the non-graphitizable carbon varies.

In the present example, the DC resistance value is calculated based on the voltage at 10 seconds after a start of discharge at each rate. The present inventors confirmed from an experiment that there is the same tendency as in Examples described above in DC resistance values calculated based on the voltage at 30 seconds after a start of discharge at each rate.

### INDUSTRIAL APPLICABILITY

Since the present invention can reduce the DC resistance at low temperatures in the negative electrode for a nonaqueous electrolyte energy storage device and the nonaqueous electrolyte energy storage device including the negative electrode, the present invention is useful in nonaqueous electrolyte energy storage devices in wide applications such as a power supply for electric vehicles and a power supply for electronic equipment, a power supply for electric power storage.

### DESCRIPTION OF REFERENCE SIGNS

1 Nonaqueous electrolyte energy storage device
2 Electrode group
3 Outer case
4 Positive electrode terminal
4′ Positive electrode lead
5 Negative electrode terminal
5′ Negative electrode lead
20 Energy storage unit
30 Energy storage apparatus

1. A negative electrode for a nonaqueous electrolyte energy storage device containing graphite, non-graphitizable carbon, and a binder, wherein an average particle size of the non-graphitizable carbon is 8 μm or less, and a ratio of the mass of the non-graphitizable carbon to a total mass of the graphite and the non-graphitizable carbon is 10% by mass or more and 50% by mass or less.

2. The negative electrode for a nonaqueous electrolyte energy storage device according to claim 1, wherein a ratio of the mass of the non-graphitizable carbon to a total mass of the graphite and the non-graphitizable carbon is 10% by mass or more and 30% by mass or less.

3. The negative electrode for a nonaqueous electrolyte energy storage device according to claim 1, wherein a ratio of the mass of the non-graphitizable carbon to a total mass of the graphite and the non-graphitizable carbon is 10% by mass or more and 20% by mass or less.

4. The negative electrode for a nonaqueous electrolyte energy storage device according to claim 1, wherein the average particle size of the non-graphitizable carbon is 2 μm or more and 4 μm or less.

5. The negative electrode for a nonaqueous electrolyte energy storage device according to claim 1, wherein the average particle size of the non-graphitizable carbon is 3 μm or more and 4 μm or less.

6. The negative electrode for a nonaqueous electrolyte energy storage device according to claim 1, wherein a shape of the non-graphitizable carbon is non-spherical.

7. A nonaqueous electrolyte energy storage device comprising the negative electrode for a nonaqueous electrolyte energy storage device according to claim 1.

8. A nonaqueous electrolyte energy storage device comprising the negative electrode for a nonaqueous electrolyte energy storage device according to claim 1, and a positive electrode for a nonaqueous electrolyte energy storage device which uses a positive active material represented by the formula Li_{w}NiₓMn_{y}Co_{1-x-y}O₂ (0<w≤1.2, 0.3<x≤0.8, 0≤y<1).

9. An energy storage apparatus comprising the nonaqueous electrolyte energy storage device according to claim 7.

10. The negative electrode for a nonaqueous electrolyte energy storage device according to claim 1, wherein the binder comprises an aqueous binder.

11. The negative electrode for a nonaqueous electrolyte energy storage device according to claim 1, wherein the binder comprises a rubber-based polymers capable of being dissolved or dispersed in an aqueous solvent.

12. The negative electrode for a nonaqueous electrolyte energy storage device according to claim 1, wherein the binder comprises a styrene-butadiene rubber, an acrylonitrile-butadiene rubber, a methyl methacrylate-butadiene rubber, or combination thereof.
